(19) United States
(12) Patent Application Publication
(10) Pub. No.: US 2025/0116255 A1
(43) Pub. Date: Apr. 10, 2025

(54) ENERGY HARVESTING APPARATUS

(71) Applicants: Hyundai Motor Company, Seoul (KR); Kia Corporation, Seoul (KR)

(72) Inventors: Jin Young Yoon, Gimpo-si (KR); Hong Heui Lee, Suwon-si (KR); Dong Eun Cha, Hwaseong-si (KR); Dong Ha Kim, Gwacheon-si (KR); Je Yeop Lim, Gyeongsan-si (KR); Bo Hwan Cha, Gyeongsan-si (KR)

(21) Appl. No.: 18/606,330

(22) Filed: Mar. 15, 2024

(30) Foreign Application Priority Data
Oct. 6, 2023 (KR) 10-2023-0133534

(51) Int. Cl. F03D 9/32; B60L 53/52; B60R 16/03; H02K 7/18; H02N 2/18

(52) U.S. Cl. CPC F03D 9/32; B60R 16/03; H02K 7/183; H02N 2/183; B60L 53/52; F05B 2240/941

(57) ABSTRACT

In an embodiment, an energy harvesting apparatus includes a housing, a first power generation unit, and a second power generation unit. In the energy harvesting apparatus according to an embodiment, electrical energy can be generated by rotation of a blade by a slipstream generated during travel of a mobility vehicle. Electrical energy can be additionally generated by pressure and impact generated during rotation of the blade. When the blade is rotated at high speed as driving speed of the mobility vehicle increases, pressure and impact can be reduced, thereby preventing damage to the blade or a piezoelectric element and thus improving the durability thereof.

### CROSS-REFERENCE TO RELATED APPLICATIONS

This application claims the benefit of Korean Patent Application No. 10-2023-0133534, filed on Oct. 6, 2023, which application is hereby incorporated herein by reference.

### TECHNICAL FIELD

The present disclosure relates to an energy harvesting apparatus of a mobility vehicle.

### BACKGROUND

There are various ways to produce energy required to drive transportation vehicles such as trains, automobiles, and ships, and research on new energy such as hydrogen energy, solar energy, and wind energy is continuously being conducted.

Such new energy is typical eco-friendly energy that is applicable to transportation means, and research is being actively conducted to apply the same to hydrogen vehicles and electric vehicles equipped with batteries having improved functions. However, vehicles using hydrogen energy have drawbacks in that charging is necessary and costly.

On the other hand, systems using wind energy or solar energy do not require recharging and are easy to manage. In particular, as depletion of fossil energy resources and environmental pollution caused by fossil energy are accelerated, wind and solar are attracting attention as new renewable alternative and eco-friendly energy sources.

Various means of transportation, such as trains, automobiles, ships, and aircraft, induce a slipstream around the same while operating, and can be provided with wind power generating devices using a slipstream.

Typically, a wind power generating device generates electrical energy through electricity-generating operation of a motor using rotation of a fan. However, it is difficult to generate a sufficient amount of electrical energy using the wind power generating device. Further, when a large number of fans is mounted therein, the wind power generating device may be undesirably increased in volume.

Further, the wind power generating device may generate electrical energy by rotating a fan using a slipstream. The wind power generating device may be configured such that, as the travel speed of a mobility vehicle increases, the rotational speed of the fan also increases. However, the conventional wind power generating device has no structure or method for preventing the fan from being damaged due to high-speed rotation thereof.

The information disclosed in this Background section is only for enhancement of understanding of the general background of the disclosure, and should not be taken as an acknowledgement or any form of suggestion that this information forms the related art already publicly known.

### SUMMARY

The present disclosure relates to an energy harvesting apparatus that generates electrical energy using a slipstream induced during travel of a mobility vehicle.

Embodiments of the present disclosure have been made in view of the above problems. An embodiment of the present disclosure can provide an energy harvesting apparatus that generates electrical energy using a slipstream induced during travel of a mobility vehicle and maximizes efficiency of generating electrical energy using a slipstream.

In accordance with an embodiment of the present disclosure, the above and other advantages can be accomplished by the provision of an energy harvesting apparatus including a housing, which includes a flow passage formed therein to allow air to flow therethrough, a first power generation unit, which is mounted to the housing, includes a rotating part and a power generation part, and is configured such that, when the rotating part is rotated by air flowing through the flow passage, the power generation part generates electrical energy using rotational force, and a second power generation unit, which is mounted to the housing and configured to be contactable with the rotating part and is configured to generate electrical energy by being struck by the rotating part when the rotating part is rotated.

The rotating part of the first power generation unit may include a blade and a rotating shaft. The blade and the power generation part may be connected to each other via the rotating shaft, and the second power generation unit may generate electrical energy through contact with the blade.

The second power generation unit may include a piezoelectric plate and a support plate. The piezoelectric plate may be configured to be contactable with the blade, may be provided to be movable in the flow passage, and may generate electrical energy through contact with the blade. The support plate may elastically support the piezoelectric plate.

The piezoelectric plate may be formed to extend in the rotational direction of the blade, and may include a through-hole formed therein to allow air to flow into the flow passage therethrough.

The blade may include a striking protrusion protruding from a surface thereof facing the piezoelectric plate. The piezoelectric plate may include a first piezoelectric element provided on a first surface thereof facing the blade.

The first piezoelectric element may be provided in plural, and the plurality of first piezoelectric elements may be configured to be spaced apart from each other in the rotational direction of the blade.

The first piezoelectric element may be formed to have an inclined surface gradually increased in height in the rotational direction of the blade.

The piezoelectric plate may include a second piezoelectric element provided on a second surface thereof facing the support plate.

The support plate may include an elastic member provided on a surface thereof facing the piezoelectric plate, and the elastic member may be configured to match the second piezoelectric element.

The support plate may include a guide pin formed on a surface thereof facing the piezoelectric plate. The guide pin may penetrate the piezoelectric plate to guide movement of the piezoelectric plate, and the elastic member may be disposed around the guide pin and may be interposed between the piezoelectric plate and the support plate.

The second piezoelectric element may be provided in plural, and the plurality of second piezoelectric elements may be configured to be spaced apart from each other in the rotational direction of the blade. The elastic member may be provided in plural to match the plurality of second piezoelectric elements.

The rotating part of the first power generation unit may include a blade and a rotating shaft. The blade and the power generation part may be connected to each other via the rotating shaft, and the second power generation unit may generate electrical energy through contact with the rotating shaft.

The housing may be divided into a flow passage and a power generation space. The blade may be located in the flow passage, and the second power generation unit and the power generation part may be located in the power generation space.

The rotating shaft may extend to penetrate the flow passage and the power generation space and may be connected to the blade and the power generation part, and may include a striking portion extending therefrom in the radial direction in the power generation space. The second power generation unit may be located within the radius of rotation of the striking portion in the power generation space.

The striking portion may include a circular distal end configured to be contactable with the second power generation unit. The second power generation unit may include a portion facing the striking portion when the striking portion is rotated, and the portion may be configured to be inclined.

The second power generation unit may be configured to generate electrical energy through elastic deformation thereof. The second power generation unit may be configured in plural, and the plurality of second power generation units may be located around the power generation part and configured to be spaced apart from each other along the outer periphery of the power generation part.

### BRIEF DESCRIPTION OF THE DRAWINGS

The above features and other advantages of the present disclosure can be more clearly understood from the following detailed description taken in conjunction with the accompanying drawings, in which:

FIG. 1 is a view showing a mobility vehicle to which an energy harvesting apparatus of an embodiment of the present disclosure is applied;

FIG. 2 is a view showing an energy harvesting apparatus according to an embodiment of the present disclosure;

FIG. 3 is an exploded view of the energy harvesting apparatus shown in FIG. 2;

FIG. 4 is a perspective view showing a piezoelectric plate of the energy harvesting apparatus shown in FIG. 2;

FIG. 5 is a perspective view showing a blade of the energy harvesting apparatus shown in FIG. 2;

FIG. 6 is a cross-section view showing the piezoelectric plate and a support plate of the energy harvesting apparatus shown in FIG. 2;

FIG. 7 is a perspective view showing the support plate of the energy harvesting apparatus shown in FIG. 2;

FIG. 8 is a perspective view showing an energy harvesting apparatus according to an embodiment of the present disclosure;

FIG. 9 is a cross-section view showing the interior of the energy harvesting apparatus shown in FIG. 8;

FIG. 10 is a perspective view showing an energy harvesting apparatus according to an embodiment of the present disclosure; and

FIG. 11 is a cross-section view showing the interior of the energy harvesting apparatus shown in FIG. 10.

### DETAILED DESCRIPTION OF ILLUSTRATIVE EMBODIMENTS

Hereinafter, embodiments disclosed in the present specification will be described in detail with reference to the accompanying drawings, and same or similar elements can be denoted by the same reference numerals even though they may be depicted in different drawings, and redundant descriptions thereof can be omitted.

In the following description, with respect to constituent elements used in the following description, the suffixes “module” and “unit” can be used for description, and do not necessarily have mutually distinguished meanings or functions.

In the following description of embodiments, a detailed description of known functions and configurations incorporated herein can be omitted when the same may make the subject matter of the embodiments unclear. In addition, the accompanying drawings are provided only for a better understanding of the embodiments disclosed in the present specification and are not necessarily intended to limit the technical ideas disclosed in the present specification. Therefore, it can be understood that the accompanying drawings include all modifications, equivalents, and substitutions within the scope and sprit of the present disclosure.

It can be understood that although the terms “first”, “second”, etc., may be used herein to describe various components, these components are not necessarily limited by these terms. These terms can be only used to distinguish one component from another component.

It can be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form can be intended to include the plural forms as well, unless the context clearly indicates otherwise.

It can be further understood that the terms “comprises”, “comprising”, “includes”, and/or “including”, when used herein, specify the presence of stated features, integers, steps, operations, elements, components, or combinations thereof, but do not preclude the presence or addition of one or more other features, integers, steps, operations, elements, components, or combinations thereof.

An energy harvesting apparatus according to an embodiment of the present disclosure will be described with reference to the accompanying drawings.

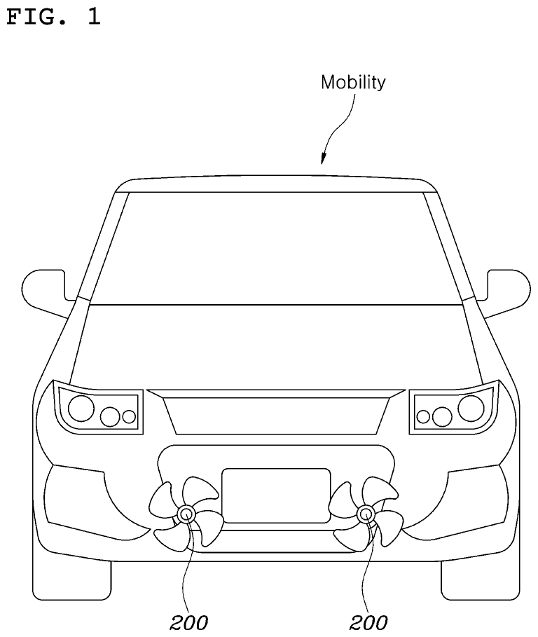

As shown in FIGS. 1 to 3, an energy harvesting apparatus according to an embodiment of the present disclosure includes a housing 100, which includes a flow passage 110 formed therein to allow air to flow therethrough, a first power generation unit 200, which is mounted to the housing 100, includes a rotating part 210 and a power generation part 220, and is configured such that, when the rotating part 210 is rotated by air flowing through the flow passage 110, the power generation part 220 generates electrical energy using rotational force, and a second power generation unit 300, which is mounted to the housing 100 and configured to be contactable with the rotating part 210 and is configured to generate electrical energy by being struck by the rotating part 210 when the rotating part 210 is rotated.

The energy harvesting apparatus according to an embodiment of the present disclosure can be an apparatus that generates electrical energy using a slipstream induced during travel of a mobility vehicle. The energy harvesting apparatus according to an embodiment of the present disclosure may be located in a place in a mobility vehicle into which a slipstream may be introduced, such as a front side or roof of the mobility vehicle.

For example, as shown in FIG. 1, the energy harvesting apparatus may be located at the front side of the mobility vehicle. To avoid interference with other parts of the mobility vehicle, the energy harvesting apparatus may be provided in a pair, and the pair of power generation units 200 may be located on both sides of the front bumper of the mobility vehicle.

An inlet and an outlet of the housing 100 can communicate with each other through the flow passage 110 formed in the housing 100, whereby air may flow through the flow passage 110.

The housing 100 may be provided with the first power generation unit 200, which includes the rotating part 210 and the power generation part 220. The rotating part 210 may be configured to be rotated by air flowing through the flow passage 110, and the power generation unit 220 may be configured to generate electrical energy using rotational force of the rotating part 210.

The rotating part 210 may include a blade 211 configured to be rotated by the flow of air, and the power generation unit 220 may be implemented as a power generation motor.

In addition, the housing 100 can be provided with the second power generation unit 300, which can be configured to be contactable with the rotating part 210. When the rotating part 210 is rotated, the second power generation unit 300 can contact the rotating part 210. When the rotating part 210 is rotated, the second power generation unit 300 can be struck by the rotating part 210, and can generate electrical energy in a piezoelectric manner.

The second power generation unit 300 may include a piezoelectric element. Piezoelectric energy harvesting using a piezoelectric element can convert mechanical energy, such as vibration, pressure, or impact, into electrical energy.

According to an embodiment of the present disclosure including the first power generation unit 200 and the second power generation unit 300, when the rotating part 210 of the first power generation unit 200 is rotated by a slipstream, the power generation part 220 can generate electrical energy, and the rotating part 210 can strike the second power generation unit 300 so that the second power generation unit 300 can generate electrical energy in a piezoelectric manner, whereby efficiency of generating electrical energy may be improved.

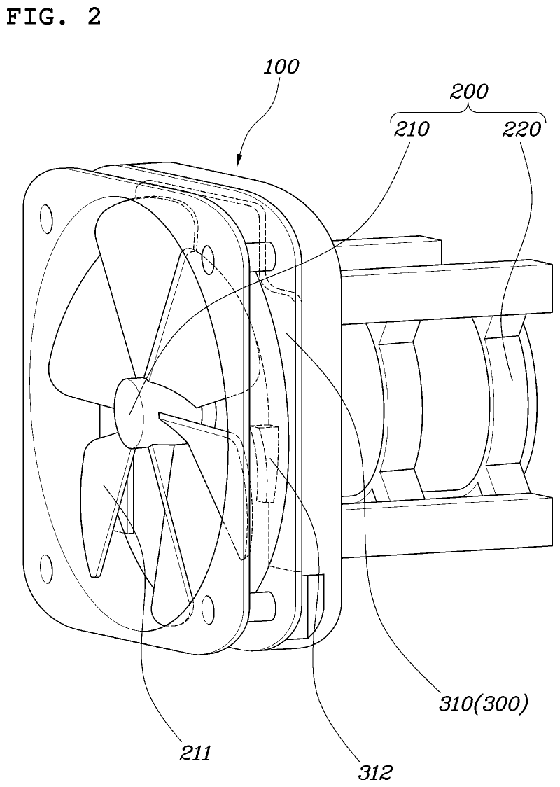

FIGS. 2 to 8 show an embodiment of the present disclosure.

The rotating part 210 of the first power generation unit 200 can include a blade 211 and a rotating shaft 212, and the blade 211 and the power generation part 220 can be connected to each other via the rotating shaft 212. The second power generation unit 300 may generate electrical energy through contact with the blade 211.

The rotating part 210 and the power generation part 220 can be provided in the flow passage 110 in the housing 100, and the rotating shaft 212 can be connected to the blade 211 and the power generation part 220. Accordingly, when the blade 211 is rotated, the power generation part 220 may receive rotational force, and may generate electrical energy using the rotational force.

In addition, the second power generation unit 300 can be located in the flow passage 110 in the housing 100 and configured to be contactable with the blade 211. Accordingly, when the blade 211 is rotated and strikes the second power generation unit 300, the second power generation unit 300 may generate electrical energy using mechanical energy such as vibration or impact.

The second power generation unit 300 may include a piezoelectric plate 310 and a support plate 320.

The piezoelectric plate 310 can be configured to be contactable with the blade 211, and can be configured to be movable in the flow passage 110. The piezoelectric plate 310 can generate electrical energy through contact with the blade 211, and the support plate 320 can elastically support the piezoelectric plate 310.

The piezoelectric plate 310 may be located behind the blade 211 based on a direction in which air flows through the flow passage 110, and may be reciprocated in the forward-backward direction by the blade 211 that is rotated.

In addition, the piezoelectric plate 310 can be configured to convert mechanical energy, such as vibration, pressure, or impact, generated by contact with the blade 211 into electrical energy.

The support plate 320 can be located behind the piezoelectric plate 310 to elastically support the piezoelectric plate 310. Even when the piezoelectric plate 310 is struck and pushed by the blade 211, the support plate 320 can return the piezoelectric plate 310 to the original position thereof so that the piezoelectric plate 310 is continuously struck by the blade 211.

The piezoelectric plate 310 may be formed to extend in the rotational direction of the blade 211, and may include a through-hole 311 formed therein to allow air to flow into the flow passage 110 therethrough.

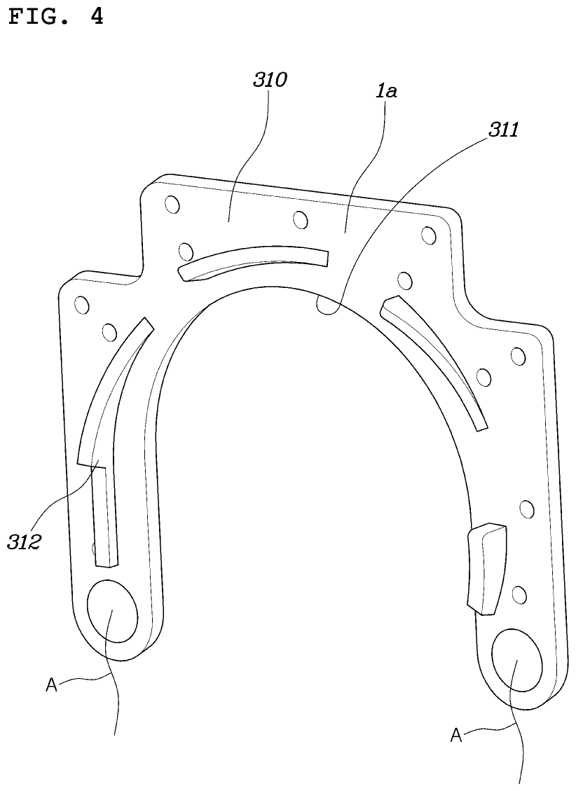

As illustrated in FIG. 4, due to the through-hole 311 formed therein, the piezoelectric plate 310 may be formed in a circular shape or an inverted U-shape that encompasses the radius of rotation of the blade 211.

Accordingly, when the blade 211 is rotated, the piezoelectric plate 310 may be continuously struck by the blade 211, and air may flow into the flow passage 110 through the through-hole 311 formed in the piezoelectric plate 310.

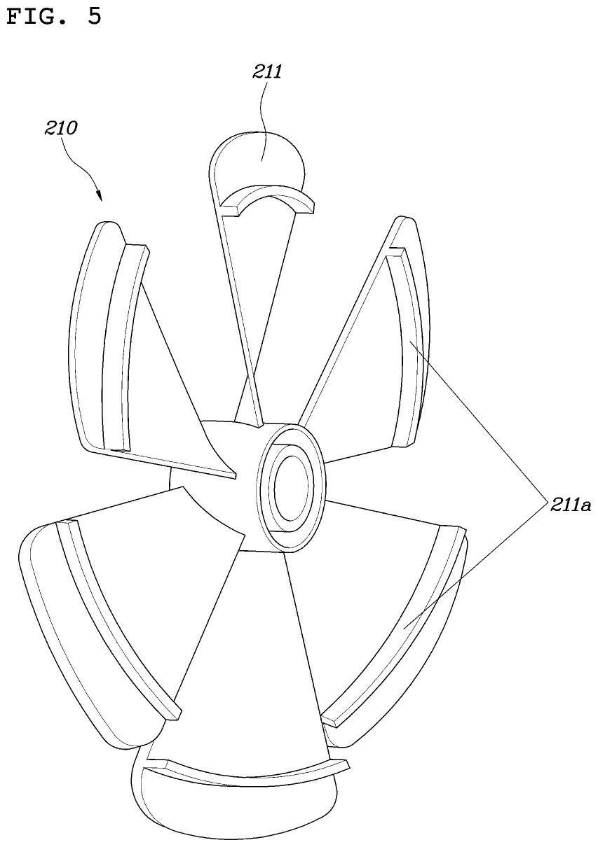

In addition, as illustrated in FIG. 5, the blade 211 may include a striking protrusion 211a protruding from a surface thereof that faces the piezoelectric plate 310.

As illustrated in FIG. 5, because the striking protrusion 211a is formed on the blade 211, the striking protrusion 211a can strike the piezoelectric plate 310 when the blade 211 is rotated, whereby the piezoelectric plate 310 may generate electrical energy.

Because the striking protrusion 211a can strike the piezoelectric plate 310, it may be possible to prevent deterioration in the rotating performance of the blade 211 due to damage to an edge of the blade 211. Further, the amount of impact applied to the piezoelectric plate 310 may be increased by contact with the striking protrusion 211a. As a result, the electrical energy generation efficiency of the piezoelectric plate 310 may be improved.

The piezoelectric plate 310 may include a first piezoelectric element 312 provided on a first surface 1a thereof that faces the blade 211.

When the blade 211 is rotated, the first piezoelectric element 312 provided on the first surface 1a of the piezoelectric plate 310 can collide with the blade 211, thereby generating electrical energy.

A power line A, through which a current can move when the first piezoelectric element 312 generates electrical energy, may be connected to the piezoelectric plate 310.

As described above, when the blade 211 is rotated, the piezoelectric plate 310 can convert mechanical energy generated by collision between the first piezoelectric element 312 and the blade 211 into electrical energy. Further, the piezoelectric plate 310 can be elastically supported by the support plate 320, and thus can be continuously struck by the blade 211 that is rotated, thereby generating electrical energy.

The first piezoelectric element 312 may be provided in plural, and the plurality of first piezoelectric elements 312 may be configured to be spaced apart from each other in the rotational direction of the blade 211.

Because the piezoelectric plate 310 can include the plurality of first piezoelectric elements 312, the amount of electrical energy generated by the first piezoelectric elements 312 may be increased.

In addition, because the first piezoelectric elements 312 can be spaced apart from each other at regular intervals in the rotational direction of the blade 211, the first piezoelectric elements 312 can collide with the blade 211 at a regular time interval, thereby reducing damage to the blade 211 due to irregular impact on the blade 211.

In addition, each of the first piezoelectric elements 312 may be formed to have an inclined surface that is gradually increased in height in the rotational direction of the blade 211.

The first piezoelectric elements 312 can protrude toward the blade 211 from the piezoelectric plate 310, and the protruding surfaces of the first piezoelectric elements 312 can be inclined so as to be gradually increased in height in the rotational direction of the blade 211. Therefore, the blade 211 may be moved along the inclined surfaces of the first piezoelectric elements 312.

Accordingly, when the blade 211 is rotated and contacts the first piezoelectric elements 312, the blade 211 can exert impact on the first piezoelectric elements 312, and can be moved along the inclined surfaces of the first piezoelectric elements 312, thereby reducing resistance to rotation of the blade 211.

Because the blade 211 can be moved along the inclined surfaces of the first piezoelectric elements 312, it may be possible to prevent the blade 211 from being caught by the first piezoelectric elements 312 and thus becoming unrotatable and to reduce damage to the blade 211 caused by collision between the blade 211 and the first piezoelectric elements 312.

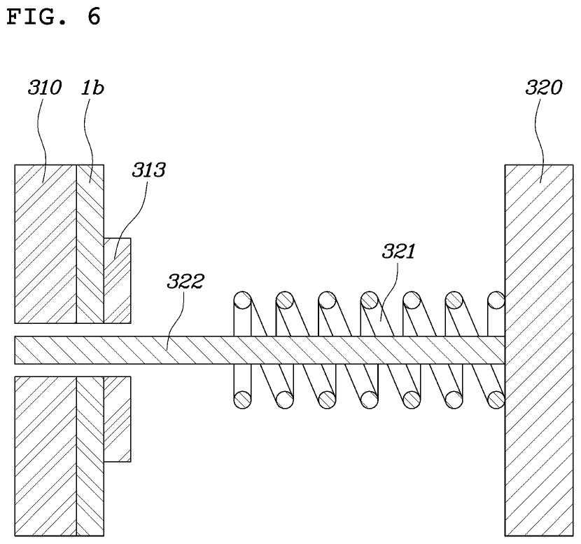

In addition, as illustrated in FIG. 6, the piezoelectric plate 310 may include a second piezoelectric element 313 provided on a second surface 1b thereof that faces the support plate 320.

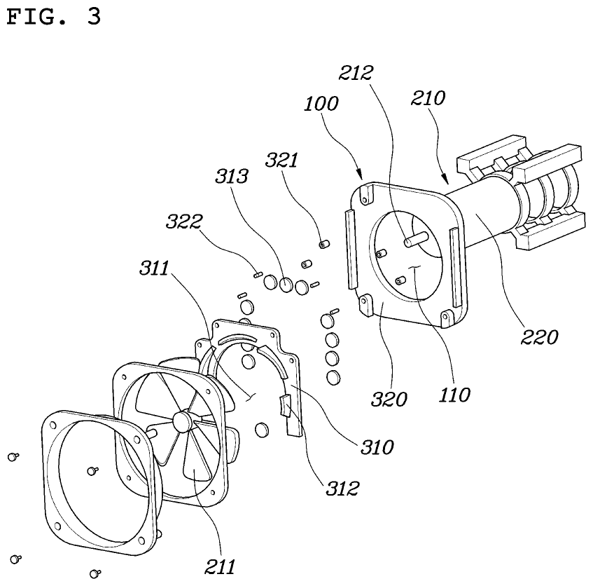

As shown in FIGS. 3 and 6, because the second piezoelectric element 313 can be provided on the second surface 1b of the piezoelectric plate 310, when the piezoelectric plate 310 is reciprocated in the forward-backward direction by the blade 211 that is rotated, the second piezoelectric element 313 may collide with the support plate 320, thereby generating electrical energy.

The second piezoelectric element 313 may be electrically connected to the power line A provided at the piezoelectric plate 310 to transmit the electrical energy to an external power supply. The second piezoelectric element 313 may be implemented as a piezoelectric film.

When the blade 211 is rotated, the piezoelectric plate 310 can be reciprocated and collides with the support plate 320, and the second piezoelectric element 313 can convert mechanical energy generated by collision into electrical energy, thereby generating electrical energy.

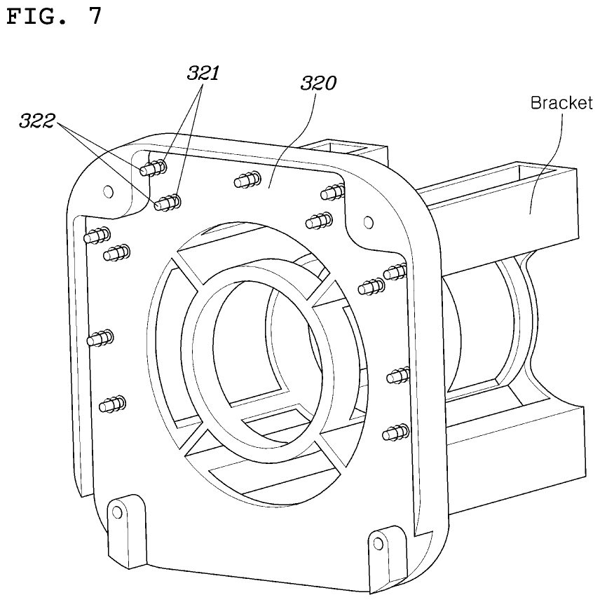

As shown in FIGS. 6 and 7, the support plate 320 may include an elastic member 321 provided on a surface thereof that faces the piezoelectric plate 310. The elastic member 321 may be configured to match the second piezoelectric element 313.

The elastic member 321 may be implemented as a spring. The elastic member 321 may be located between the piezoelectric plate 310 and the support plate 320 to elastically support the piezoelectric plate 310 against the support plate 320.

Accordingly, even when the piezoelectric plate 310 is struck and pushed by the blade 211, the elastic member 321 can return the piezoelectric plate 310 to the original position thereof so that the piezoelectric plate 310 can be continuously or repeatedly struck by the blade 211.

The elastic member 321 may be configured to match the second piezoelectric element 313 in terms of the number and position thereof, and may be in contact with the second piezoelectric element 313.

In addition, the support plate 320 may include a guide pin 322 formed on the surface thereof that faces the piezoelectric plate 310. The guide pin 322 may penetrate the piezoelectric plate 310 to guide movement of the piezoelectric plate 310. The elastic member 321 may be placed around the guide pin 322 and may be interposed between the piezoelectric plate 310 and the support plate 320.

The guide pin 322 may be fixed to the support plate 320, and may extend toward the piezoelectric plate 310 and be configured to penetrate the piezoelectric plate 310, whereby the piezoelectric plate 310 may be moved along the guide pin 322.

Further, the guide pin 322 can be inserted through the elastic member 321 such that the elastic member 321 is interposed between the piezoelectric plate 310 and the support plate 320. The elastic member 321 may be implemented as a spring, and the position thereof may be maintained between the piezoelectric plate 310 and the support plate 320 due to the guide pin 322 inserted therethrough.

Because the piezoelectric plate 310 can be movable along the guide pin 322, the piezoelectric plate 310 may be moved along the guide pin 322 when struck by the blade 211. Further, because the elastic member 321 can be located around the guide pin 322 and elastically support the piezoelectric plate 310, the piezoelectric plate 310 may be reciprocated along the guide pin 322.

The second piezoelectric element 313 may be provided in plural, and the plurality of second piezoelectric elements 313 may be configured to be spaced apart from each other in the rotational direction of the blade 211. The elastic member 321 may also be configured in plural to match the plurality of second piezoelectric elements 313.

Because the plurality of second piezoelectric elements 313 can be provided on the piezoelectric plate 310, the amount of electrical energy generated by the second piezoelectric elements 313 may be increased.

Because the second piezoelectric elements 313 can be spaced apart from each other at regular intervals in the rotational direction of the blade 211 and the elastic members 321 can match the second piezoelectric elements 313, the elastic members 321 may elastically support the piezoelectric plate 310 as well as the second piezoelectric elements 313 in a balanced manner.

In addition, the second piezoelectric elements 313 may generate electrical energy using impact, vibration, or pressure generated by contact with the elastic members 321. Because the elastic members 321 can be deformed when contacting the second piezoelectric elements 313, the amount of vibration energy generated may be increased, and thus efficiency of generating electrical energy may be improved.

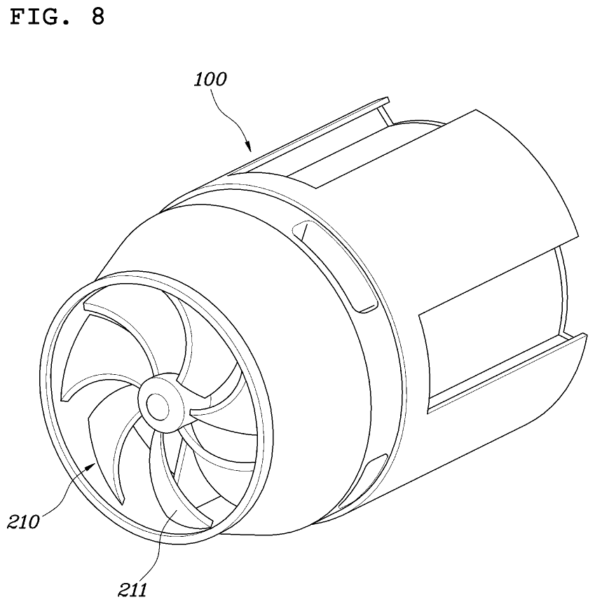

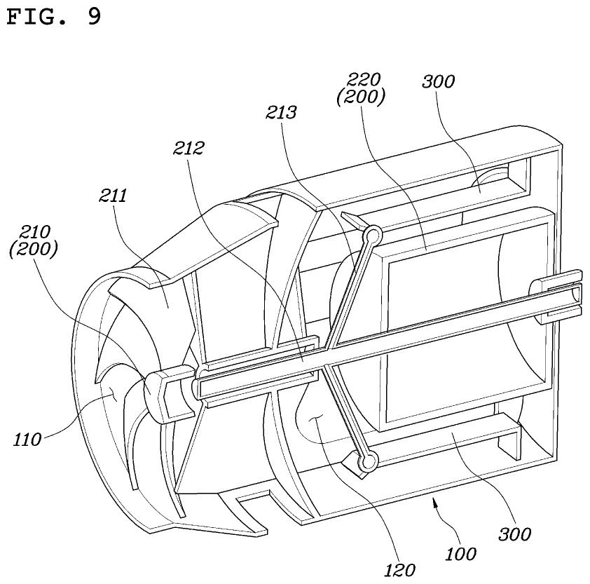

According to an embodiment of the present disclosure, as shown in FIGS. 8 and 9, the rotating part 210 of the first power generation unit 200 may include a blade 211 and a rotating shaft 212, the blade 211 and the power generation part 220 may be connected to each other via the rotating shaft 212, and the second power generation unit 300 may generate electrical energy through contact with the rotating shaft 212.

When the blade 211 of the rotating part 210 constituting the first power generation unit 200 is rotated by a slipstream, the rotating shaft 212 can be rotated to cause the power generation part 220 to generate electrical energy. Further, the second power generation unit 300 can be struck by the rotating shaft 212 that is rotated, thereby generating electrical energy in a piezoelectric manner.

The housing 100 may be divided into a flow passage 110 and a power generation space 120. The blade 211 may be disposed in the flow passage 110, and the second power generation unit 300 and the power generation part 220 may be located in the power generation space 120.

Accordingly, the blade 211 of the rotating part 210 may be rotated by the flow of air in the flow passage 110 through an inlet and an outlet of the housing 100. The power generation space 120 accommodating the second power generation unit 300 and the power generation part 220 may be sealed to prevent external contamination.

An energy harvesting apparatus according to an embodiment can be configured such that the rotating shaft 212 strikes the second power generation unit 300 while being rotated.

The rotating shaft 212 may extend so as to penetrate the flow passage 110 and the power generation space 120 and may be connected to the blade 211 and the power generation part 220, and may include a striking portion 213 extending therefrom in the radial direction in the power generation space 120. The second power generation unit 300 may be positioned within the radius of rotation of the striking portion 213 in the power generation space 120.

Because the rotating shaft 212 can penetrate the flow passage 110 and the power generation space 120, the rotating shaft 212 may be connected to the blade 211 in the flow passage 110 and to the power generation part 220 in the power generation space 120. In addition, because the striking portion 213 can extend in the radial direction in the power generation space 120, the striking portion 213 may contact the second power generation unit 300 while being rotated.

Because the second power generation unit 300 can be located within the radius of rotation of the striking portion 213 in the power generation space 120, the second power generation unit 300 can be struck by the striking portion 213 that is rotated with the radius of rotation thereof along with rotation of the rotating shaft 212, thereby converting mechanical energy generated by collision into electrical energy.

The striking portion 213 may include a circular distal end configured to be contactable with the second power generation unit 300. The second power generation unit 300 may include a portion that faces the striking portion 213 when the striking portion 213 is rotated, and the portion may be formed to be inclined.

Because the striking portion 213 can extend from the rotating shaft 212 and include a circular distal end and the portion of the second power generation unit 300 that contacts the striking portion 213 can be bent to be inclined, the striking portion 213 contacting the second power generation unit 300 can slide on the bent portion of the second power generation unit 300, thereby reducing resistance to rotation of the striking portion 213.

Accordingly, when the striking portion 213 is rotated and contacts the second power generation unit 300, the striking portion 213 can exert impact on the second power generation unit 300, and then can slide on the bent portion of the second power generation unit 300, thereby being prevented from being caught by the second power generation unit 300 and thus becoming unrotatable.

In addition, the second power generation unit 300 may be configured to generate electrical energy through elastic deformation thereof. The second power generation unit 300 may be provided in plural, and the plurality of second power generation units 300 may be located around the power generation part 220 and configured to be spaced apart from each other along the outer periphery of the power generation part 220.

Each of the plurality of second power generation units 300 may be implemented as a piezoelectric element. When the striking portion 213 is rotated and contacts the second power generation units 300, the second power generation units 300 can convert mechanical energy into electrical energy.

Because the plurality of second power generation units 300 can be configured to be spaced apart from each other along the outer periphery of the power generation part 220, the amount of electrical energy generated may be increased in proportion to increase in the number of second power generation units 300 contacting the striking portion 213. Further, the overall size of the apparatus may be reduced through optimal placement of the power generation part 220 and the second power generation units 300.

As a result, the power generation part 220 may convert the rotational force of the single rotating shaft 212 into electrical energy, and at the same time, the striking portion 213 may be rotated along with rotation of the rotating shaft 212 and may strike the second power generation units 300, whereby the second power generation units 300 may also generate electrical energy.

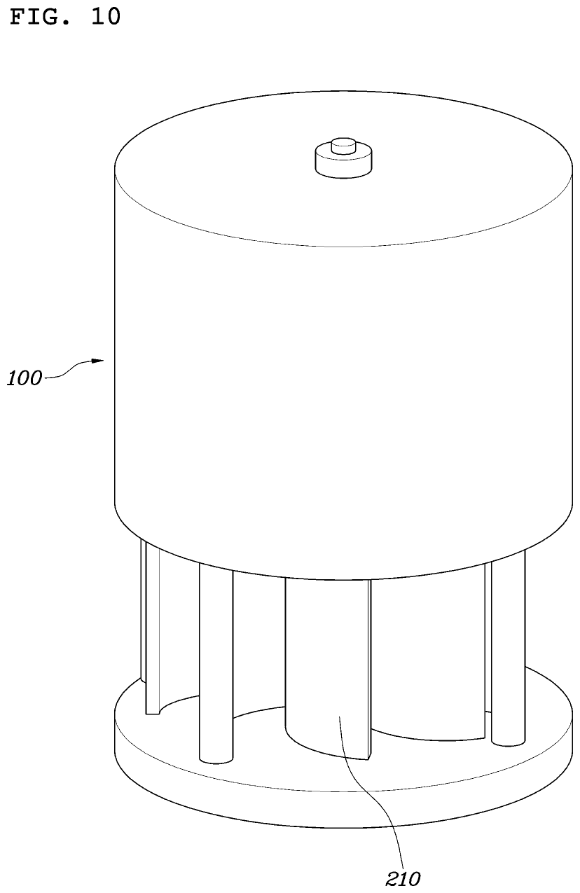

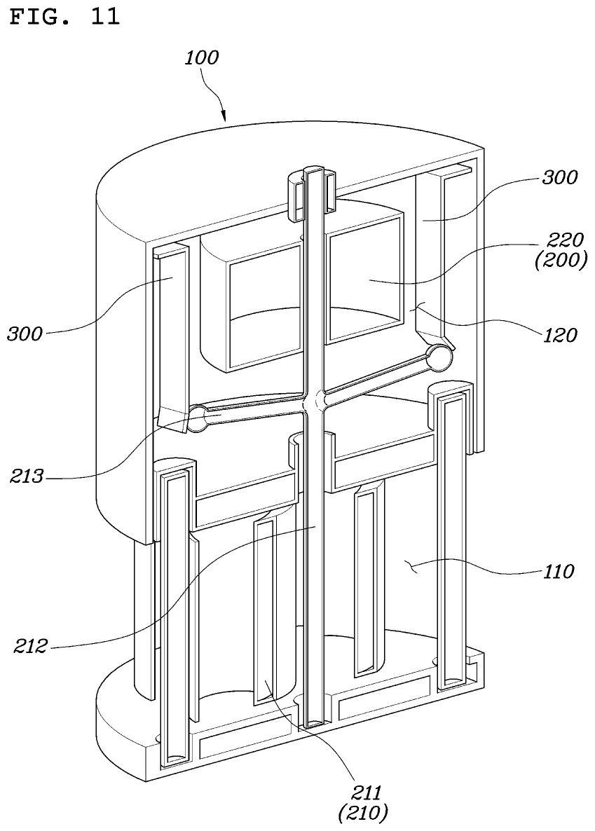

As shown in FIGS. 8 and 9, the energy harvesting apparatus according to an embodiment may be placed in a horizontal direction to generate electrical energy using a slipstream introduced thereinto in a direction opposite the travel direction of the mobility vehicle. Alternatively, as shown in FIGS. 10 and 11, the energy harvesting apparatus according to an embodiment may be placed in a vertical direction, and thus may be mounted in various places in the mobility vehicle to generate electrical energy.

As can be apparent from the above description, according to the energy harvesting apparatus structured as described above, electrical energy can be generated by rotation of the blade by a slipstream generated during travel of the mobility vehicle. Further, electrical energy can be additionally generated by pressure and impact generated during rotation of the blade. Accordingly, the amount of electrical energy generated can be increased.

In addition, when the blade is rotated at high speed as the driving speed of the mobility vehicle increases, pressure and impact can be reduced, thereby preventing damage to the blade or the piezoelectric element and thus improving the durability thereof.

Although embodiments of the present disclosure have been disclosed for illustrative purposes, those skilled in the art can appreciate that various modifications, additions, and substitutions can be possible, without departing from the scope and spirit of the disclosure as disclosed in the accompanying claims.

What is claimed is:

1. An energy harvesting apparatus comprising:
a housing comprising a flow passage formed therein configured to allow air to flow therethrough;
a first power generation unit mounted to the housing, the first power generation unit comprising a rotating part and a power generation part, the first power generation unit being configured such that, when the rotating part is rotated by air flowing through the flow passage, the power generation part generates electrical energy using rotational force; and
a second power generation unit mounted to the housing and configured to be contactable with the rotating part, the second power generation unit being configured to generate electrical energy by being struck by the rotating part when the rotating part is rotated.

2. The apparatus of claim 1, wherein the rotating part of the first power generation unit comprises a blade and a rotating shaft,
wherein the blade and the power generation part are connected to each other via the rotating shaft, and
wherein the second power generation unit is configured to generate electrical energy through contact with the blade.

3. The apparatus of claim 2, wherein the second power generation unit comprises a piezoelectric plate and a support plate,
wherein the piezoelectric plate is configured to be contactable with the blade, movable in the flow passage, and generate electrical energy through contact with the blade, and
wherein the support plate elastically supports the piezoelectric plate.

4. The apparatus of claim 3, wherein the piezoelectric plate extends in a rotational direction of the blade, and wherein the piezoelectric plate comprises a through-hole formed therein to allow air to flow into the flow passage therethrough.

5. The apparatus of claim 3, wherein the blade comprises a striking protrusion protruding from a surface thereof facing the piezoelectric plate.

6. The apparatus of claim 3, wherein the piezoelectric plate comprises a first piezoelectric element provided on a first surface thereof facing the blade.

7. The apparatus of claim 6, wherein the first piezoelectric element is provided in plural, and the plurality of first piezoelectric elements is configured to be spaced apart from each other in a rotational direction of the blade.

8. The apparatus of claim 6, wherein the first piezoelectric element is formed to have an inclined surface gradually increased in height in a rotational direction of the blade.

9. The apparatus of claim 3, wherein the piezoelectric plate comprises a second piezoelectric element provided on a second surface thereof facing the support plate.

10. The apparatus of claim 9, wherein the support plate comprises an elastic member provided on a surface thereof facing the piezoelectric plate, and
wherein the elastic member is configured to match the second piezoelectric element.

11. The apparatus of claim 10, wherein the support plate comprises a guide pin formed on a surface thereof facing the piezoelectric plate,
wherein the guide pin penetrates the piezoelectric plate to guide movement of the piezoelectric plate, and
wherein the elastic member is located around the guide pin and is interposed between the piezoelectric plate and the support plate.

12. The apparatus of claim 10, wherein the second piezoelectric element is provided in plural, and the plurality of second piezoelectric elements is configured to be spaced apart from each other in a rotational direction of the blade, and
wherein the elastic member is configured in plural to match the plurality of second piezoelectric elements.

13. An energy harvesting apparatus comprising:
a housing comprising a flow passage formed therein configured to allow air to flow therethrough;
a first power generation unit mounted to the housing, the first power generation unit comprising a rotating part and a power generation part, the first power generation unit being configured such that, when the rotating part is rotated by air flowing through the flow passage, the power generation part generates electrical energy using rotational force; and
a second power generation unit mounted to the housing and configured to be contactable with the rotating part, the second power generation unit being configured to generate electrical energy by being struck by the rotating part when the rotating part is rotated,
wherein the rotating part of the first power generation unit comprises a blade and a rotating shaft,
wherein the blade and the power generation part are connected to each other via the rotating shaft, and
wherein the second power generation unit is configured to generate electrical energy through contact with the rotating shaft.

14. The apparatus of claim 13, wherein the housing is divided into a flow passage and a power generation space,
wherein the blade is located in the flow passage, and
wherein the second power generation unit and the power generation part are located in the power generation space.

15. The apparatus of claim 14, wherein the rotating shaft extends to penetrate the flow passage and the power generation space and is connected to the blade and the power generation part, and wherein the rotating shaft comprises a striking portion extending therefrom in a radial direction in the power generation space, and
wherein the second power generation unit is positioned within a radius of rotation of the striking portion in the power generation space.

16. The apparatus of claim 15, wherein the striking portion comprises a circular distal end configured to be contactable with the second power generation unit, and
wherein the second power generation unit comprises an inclined portion facing the striking portion when the striking portion is rotated.

17. The apparatus of claim 14, wherein the second power generation unit is configured to generate electrical energy through elastic deformation thereof, and
wherein the second power generation unit is provided in plural, and the plurality of second power generation units is located around the power generation part and configured to be spaced apart from each other along an outer periphery of the power generation part.
